(19) United States
(12) Patent Application Publication
(10) Pub. No.: US 2016/0126002 A1
(43) Pub. Date: May 5, 2016

(54) Wireless Charging and Near Field Communication Dual Coils PCB Structure

(71) Applicant: TDK TAIWAN Corporation, Taipei City (TW)

(72) Inventors: Feng-Lung CHIEN, Yangmei Taoyuan (TW); Takahiro OISHI, Yangmei Taoyuan (TW); Mao-Chun CHEN, Yangmei Taoyuan (TW); Chi-Fu WU, Yangmei Taoyuan (TW); Chao-Neen CHANG, Yangmei Taoyuan (TW)

(21) Appl. No.: 14/621,095

(22) Filed: Feb. 12, 2015

(30) Foreign Application Priority Data
Oct. 29, 2014 (TW) 103137312

(51) Int. Cl. H01F 27/28; H01F 38/14; H01F 27/29; H02J 7/02

(52) U.S. Cl. CPC H01F 27/2804; H02J 7/025; H01F 38/14; H01F 27/29; H01F 2027/2809

(57) ABSTRACT

A wireless charging (WLC) (A4WP) and near field communication (NFC) dual coils PCB structure comprising at least one WLC (A4WP) coil wire having spiral shape and disposed on a printed circuit board (PCB), and a NFC coil wire having spiral shape and disposed on the PCB. At least a portion of the coil wire of the spiral WLC (A4WP) coil is located on a region between two adjacent coil wires of the spiral NFC coil. Therefore, the present invention makes use of spaces of WLC (A4WP) coil such as A4WP or other relevant standards combined with the NFC coil, so that the dual coil of the present invention can reduce the area of the PCB occupied by the electronic device.

### BACKGROUND OF THE INVENTION

1. Field of the Invention

The present invention relates to a dual coils PCB structure, especially to a wireless charging (WLC) A4WP and near field communication (NFC) dual coils PCB structure.

2. Description of the Prior Art

The portable electronic devices, such as PDAs, palm computers, laptop computers or tablet computers, generally use rechargeable battery as power source, so user can still use the portable electronic devices when wall socket power is not available. The portable electronic devices are also equipped with wired power supply to charge the rechargeable battery or power the portable electronic devices with wall socket power.

The rechargeable battery in the portable electronic devices can be charged with electromagnetic induction (such as A4WP wireless charging techniques); therefore a physical power line can be dispensed with. FIG. 1 is a schematic diagram showing the wireless charging scheme. The shown wireless charging scheme comprises a power transmitting module 10 and a power receiving module 20. The power transmitting module 10 comprises a transmitting-end coil 11 and a transmitting-end ferrite plate 12. The power receiving module 20 correspondingly comprises a receiving-end coil 21 and a receiving-end ferrite plate 22. When the power receiving module 20 is in proximity of the power transmitting module 10 and electrical current flows through the transmitting-end coil 11 to generate magnetic field, the receiving-end coil 21 of the power receiving module 20 will generate electrical current induced by the magnetic field.

Moreover, near field communication (NFC) is also an important issue for portable electronic devices because NFC provides non-contact point-to-point communication for the portable electronic devices. Therefore NFC provides fast and convenient data communication way for portable electronic devices.

The current NFC technology is evolved from RFID technology allowing two ways communication. NFC is used in lots of applications such as contactless smart card in mass rapid transit system. The smart cards using NFC technology have less sensing time in comparison with other contactless smart card and are useful for traffic system with lots of passengers. The portable electronic devices (such as smart phones) integrated with NFC chip are now commercially available and it is inevitable to integrate both the wireless charging function (such as A4WP) and NFC function in portable electronic devices.

FIG. 2 is a schematic view showing prior art WLC coil and NFC coil, which are arranged on the same circuit board. In the structure shown in FIG. 2, the NFC coil 31 and the WLC coil 32 are operated in different frequency bands. More particularly, the NFC coil 31 has shorter length and is operated with two-ways communication frequency; the WLC coil 32 has longer length and is operated with one-way power transmission frequency.

Moreover, there are three major wireless charging standards in the market, namely, A4WP (Alliance for Wireless Power) standard, PMA (Power Matters Alliance) standard, and WPC (Wireless Power Consortium) standard. Following the standards, the wireless charging apparatus can support wireless charging function for various electronic devices. The standardization of wireless charging allows the products adopting the same standard can be complied with each other, thus promoting the wireless charging technology. However, the circuit board mounting the WLC coil generally is area-restricted by certain standard, and the restricted area of the circuit board should be enlarged if NFC chip is to be mounted thereon. This is in disadvantageous to the compact requirement of portable electronic devices. It is an object of the present invention to provide WLC (such as A4WP) and NFC dual coils PCB structure to arrange WLC coil and NFC chip on circuit board with standard-restricted area.

### SUMMARY OF THE INVENTION

It is an object of the present invention to provide a wireless charging (WLC) and near field communication (NFC) dual coils PCB structure, where the NFC coil can be arranged on a remaining space of the printed circuit board on which the WLC coil is not formed while the arrangement of the WLC coil still can comply with A4WP or other standards, thus saving the space of the printed circuit board.

Accordingly, the present invention provides a wireless charging (WLC) and near field communication (NFC) dual coils printed circuit board structure, comprising: at least one WLC coil having spiral coil wires and arranged on at least a face of a printed circuit board (PCB); at least one NFC coil having spiral coil wires and arranged on the face of the PCB, wherein at least a portion of the coil wires of the WLC coil are arranged on a region between two adjacent spiral coil wires of the NFC coil.

According to an aspect of the present invention, the spiral coil wires of the WLC coil are interlaced with the spiral coil wires of the NFC coil with 1:1 ratio. The spiral coil wires of the WLC coil have larger width than the spiral coil wires of the NFC coil.

According to another aspect of the present invention, the spiral coil wires of the WLC coil are interlaced with the spiral coil wires of the NFC coil with M:1 ratio, where M is an integer equal to or larger than two. The spiral coil wires of the WLC coil have substantial the same or the similar width as the spiral coil wires of the NFC coil.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram showing the prior art wireless charging scheme.

FIG. 2 is a schematic view showing prior art WLC coil and NFC coil, which are arranged on the same circuit board.

FIG. 3 shows a schematic view of the WLC (A4WP) and NFC dual coils PCB structure according to an embodiment of the present invention.

FIG. 4 shows a sectional view along line A-A in FIG. 3.

FIG. 5 shows a schematic view of the WLC (A4WP) and NFC dual coils PCB structure according to another embodiment of the present invention.

FIG. 6 shows a sectional view along line A-A in FIG. 5.

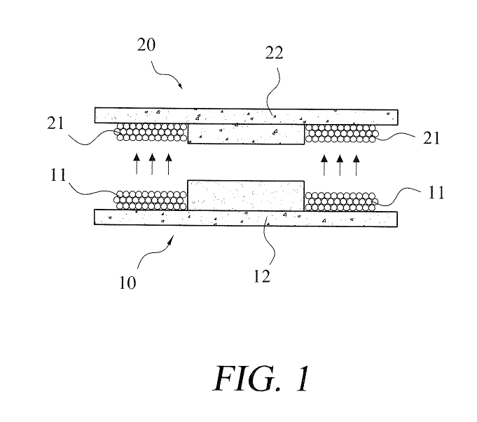

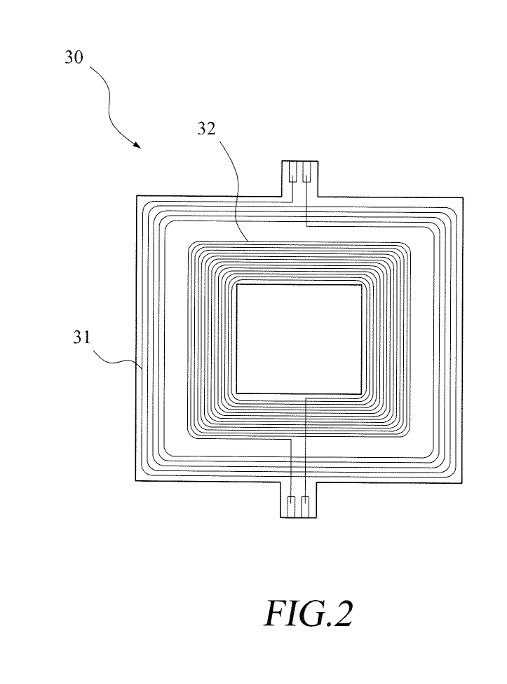

### DETAILED DESCRIPTION OF THE INVENTION

Hereinafter, the embodiments of the present invention will be described with reference to the associated drawings. It should be noted various exemplary embodiments shown in the figures are merely illustrative representations and are not necessarily the limit of the claim scope.

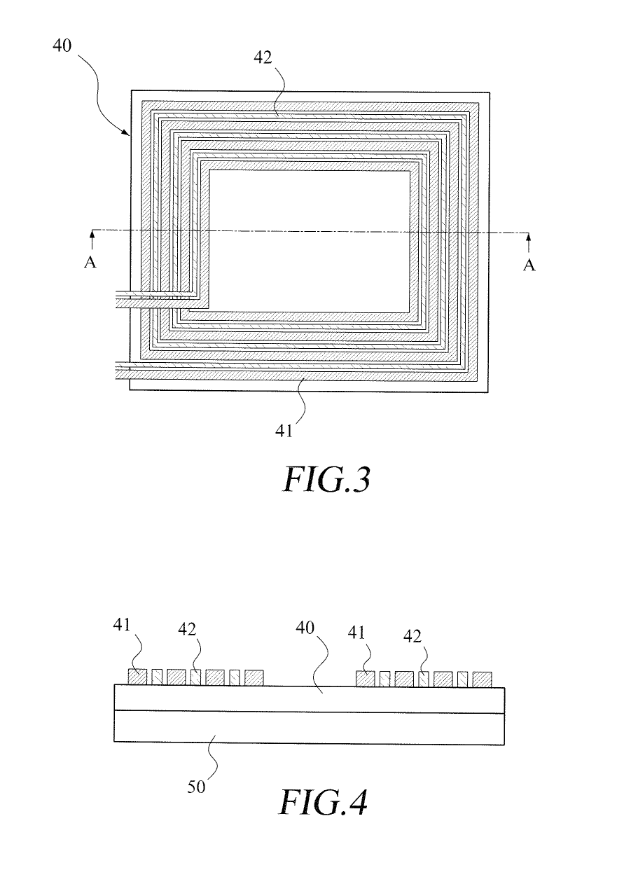

With reference to FIGS. 3 and 4, FIG. 3 shows a schematic view of the WLC (A4WP) and NFC dual coils PCB structure according to an embodiment of the present invention, and FIG. 4 shows a sectional view along line A-A in FIG. 3. The embodiment shown in FIGS. 3 and 4 comprises a printed circuit board 40, which can be a single-faced circuit board. At least one WLC coil 41 complied with A4WP standard and at least one NFC coil 42 are arranged on a face of the printed circuit board 40. The printed circuit board 40 is arranged on a ferrite plate 50 such that the printed circuit board 40 can function as an induction-transmission plate for A4WP charging.

The coil wire of the WLC (A4WP) coil 41 is spirally arranged on one face of the printed circuit board 40, and the coil wire of the NFC coil 42 is also spirally arranged on one face of the printed circuit board 40. The WLC (A4WP) coil 41 and the NFC coil 42 are formed or arranged on the single-faced printed circuit board 40 by etching, coating or electro-plating. The present invention is different with the prior art in that at a portion of coil wire of the WLC coil 41 is placed on a region between two adjacent coil wires of the NFC coil 42. Therefore, the NFC coil 42 can be arranged on a remaining space of the printed circuit board 40 on which the WLC (A4WP) coil 41 is not formed while the arrangement of the WLC coil 41 still can comply with A4WP or other standards, thus saving the space of the printed circuit board 40.

As shown in FIGS. 3 and 4, part of the spiral coil wires of the WLC (A4WP) coil 41 are interlaced with the spiral coil wires of the NFC coil 42 with 1:1 ratio. In other word, a coil wire of the WLC (A4WP) coil 41 is arranged on a region between two adjacent coil wires of the NFC coil 42. Similarly, a coil wire of the NFC coil 42 is arranged on a region between two adjacent coil wires of the WLC (A4WP) coil 41. Moreover, the spiral coil wire of the WLC (A4WP) coil 41 has larger width than the spiral coil wire of the NFC coil 42 such that the WLC (A4WP) coil 41 can conduct larger current.

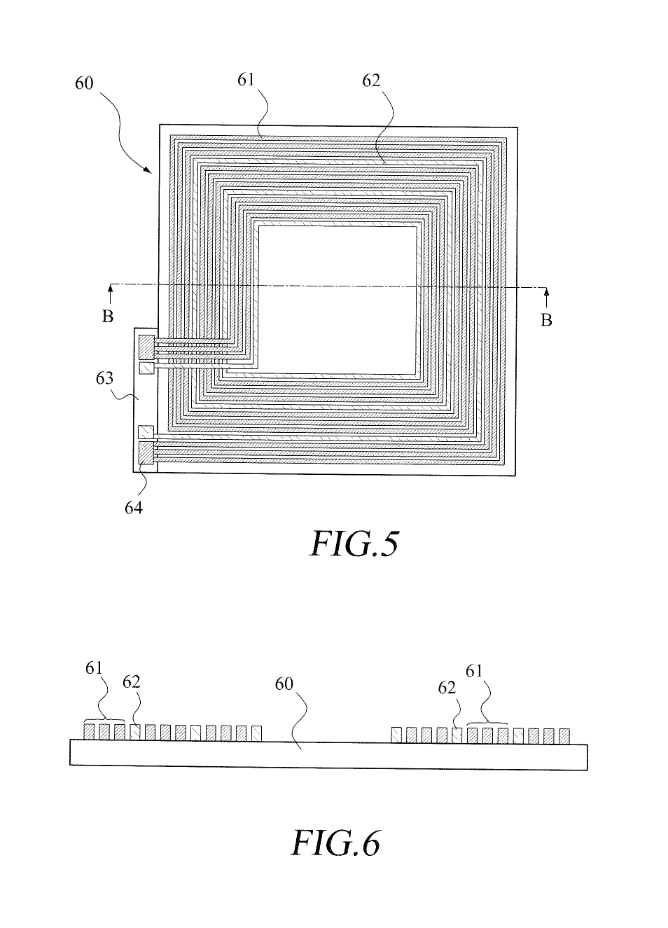

With reference to FIGS. 5 and 6, FIG. 5 shows a schematic view of the WLC (A4WP) and NFC dual coils PCB structure according to another embodiment of the present invention, and FIG. 6 shows a sectional view along line A-A in FIG. 5. The embodiment shown in FIGS. 5 and 6 comprises a printed circuit board 60, which can be a double-faced circuit board or a multi-layer circuit board. The material of the circuit can be phenol copper board, epoxy copper board, glass-epoxy copper board, glass composite copper board, benzene resin copper board, or flexible copper board with polymer or polyester material.

At least one WLC (A4WP) coil 61 or at least one NFC coil 62 is arranged on one face of the PCB 60, two faces of the PCB 60 or an inter-layer of PCB 60. The coil wires of the WLC (A4WP) coil 61 and the NFC coil 62 are of spiral shape, such as circular spiral shape, rectangular spiral shape or polygonal spiral shape. In this embodiment, the wires are of rectangular spiral shape, and can be formed on the two faces of the PCB or multi-layers of the PCB by etching, coating or electro-plating. Part of the plurality of the spiral coil wires of the WLC (A4WP) coil 61 are arranged on a region between two adjacent spiral coil wires of the NFC coil 62. The spiral coil wires of the WLC (A4WP) coil 61 are interlaced with the spiral wire of the NFC coil 62 with M:1 ratio, where M is an integer equal to or larger than two. In the shown embodiment, the ratio of the spiral coil wires of the WLC (A4WP) coil 61 and the spiral wire of the NFC coil 62 is 3:1. In other word, three coil wires of the WLC (A4WP) coil 61 are arranged on a region between two adjacent coil wires of the NFC coil 62.

In this embodiment, the spiral coil wire of the WLC (A4WP) coil 61 has substantial the same or the similar width as the spiral coil wire of the NFC coil 62. The coil wires of the WLC (A4WP) coil 61 and the NFC coil 62 can be interlaced through different layers in the PCB 60. Moreover, in this embodiment, at least one connection edge part 63 having a plurality of connection pads 64 is provided on a lateral side of the PCB 60. The connection points 64 are respectively connected to two wire terminals of the spiral coil wires of the WLC (A4WP) coil 61, and/or two wire terminals of the spiral coil wires of the NFC coil 62. Moreover, the two wire terminals of the WLC (A4WP) coil 61 can be electrically connected to the connection pads 64 of the connection edge part 63 through another face of the PCB 60 or inter-layer of the PCB 60 such that the terminal coil wires of the WLC (A4WP) coil 61 stride cross the other interlaced coil wires. Moreover, two wire terminals of the NFC coil 62 can be electrically connected to the connection pads 64 of the connection edge part 63 through another face of the PCB 60 or inter-layer of the PCB 60 such that the terminal coil wires of the NFC coil 62 stride cross the other interlaced coil wires.

To sum up, the present invention provides a WLC (such as A4WP) and NFC dual coils PCB structure to arrange WLC coil and NFC chip on circuit board with standard-restricted area. The NFC coil can be arranged on a remaining space of the printed circuit board on which the WLC coil is not formed while the arrangement of the WLC coil still can comply with A4WP or other standards, thus saving the space of the printed circuit board.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A wireless charging (WLC) (A4WP) and near field communication (NFC) dual coils printed circuit board structure, comprising:
at least one WLC (A4WP) coil having spiral coil wires and arranged on at least a face of a printed circuit board (PCB);
at least one NFC coil having spiral coil wires and arranged on the face of the PCB, wherein at least a portion of the coil wires of the WLC (A4WP) coil are arranged on a region between two adjacent spiral coil wires of the NFC coil.

2. The dual coils PCB structure in claim 1, wherein the spiral coil wires of the WLC (A4WP) coil are interlaced with the spiral coil wires of the NFC coil with 1:1 ratio.

3. The dual coils PCB structure in claim 2, wherein the spiral coil wires of the WLC coil have larger width than the spiral coil wires of the NFC coil.

4. The dual coils PCB structure in claim 1, wherein the spiral coil wires of the WLC (A4WP) coil are interlaced with the spiral coil wires of the NFC coil with M:1 ratio, where M is an integer equal to or larger than two.

5. The dual coils PCB structure in claim 4, wherein the spiral coil wires of the WLC (A4WP) coil have substantial the same or the similar width as the spiral coil wires of the NFC coil.

6. The dual coils PCB structure in claim 1, wherein the PCB is single-faced board, two-faced board or multi-layer board.

7. The dual coils PCB structure in claim 1, wherein the PCB is arranged on a ferrite plate.

8. The dual coils PCB structure in claim 1, wherein the coil wires of the WLC (A4WP) coil and the NFC coil are of circular spiral shape, rectangular spiral shape or polygonal spiral shape and arranged on the face of the PCB.

9. The dual coils PCB structure in claim 1, further comprising at least one connection edge part having a plurality of connection pads and provided on a lateral side of the PCB, the connection pads respectively connected to two wire terminals of the spiral coil wires of the WLC (A4WP) coil, and/or two terminals of the spiral coil wires of the NFC coil.

10. The dual coils PCB structure in claim 9, wherein one of the wire terminals of the WLC (A4WP) coil is electrically connected to one of the connection pads of the connection edge part through another face of the PCB or inter-layer of the PCB.

11. The dual coils PCB structure in claim 9, wherein one of the wire terminals of the NFC coil is electrically connected to one of the connection pads of the connection edge part through another face of the PCB or inter-layer of the PCB.
